(19) United States
(12) Patent Application Publication
(10) Pub. No.: US 2021/0289799 A1
(43) Pub. Date: Sep. 23, 2021

(54) MEAT PROCESSING METHODS

(71) Applicant: Cal Poly Corporation, San Luis Obispo, CA (US)

(72) Inventor: Iksoon Kang, San Luis Obispo, CA (US)

(21) Appl. No.: 17/249,914

(22) Filed: Mar. 18, 2021

Related U.S. Application Data
(60) Provisional application No. 62/991,371, filed on Mar. 18, 2020.

(51) Int. Cl. A22B 5/00; A23B 4/005; A23B 4/023; A23B 4/06; A23B 4/20; A23B 4/30

(52) U.S. Cl. CPC A22B 5/0082; A23B 4/0053; A23B 4/023; A23V 2002/00; A23B 4/20; A23B 4/30; A22B 5/0076; A23B 4/06

(57) ABSTRACT

Meat processing methods providing reduced contamination from microbial sources, improved tenderness of the resulting meat product, and enhanced processing efficiency by decreasing cost, water usage, wastewater output, time, and energy necessary for processing meat carcasses are disclosed. The methods utilize hot water spray of the carcass in addition to subzero chilling. The methods reduce bacterial population during meat production, including both Gram-negative and Gram-positive bacteria. The hot water also cleans the carcass before exposure to the chilled water such that the chilled water can be used repeatedly.

### CROSS REFERENCE TO RELATED APPLICATIONS

This application claims priority to provisional application U.S. Ser. No. 62/991,371, filed Mar. 18, 2020, which is incorporated herein by reference in its entirety.

### TECHNICAL FIELD

The present disclosure relates to animal processing technology, particularly methods providing increased processing efficiency, enhanced product safety, improved meat tenderness, increased water-use efficiency, and reduced wastewater generation.

### BACKGROUND

The primary purpose of carcass chilling after animal slaughter is to reduce microbial growth to a level that will maximize food safety and product shelf-life for consumers and marketing (Sams, 2001). Inadequate or delayed chilling may lead to the growth of spoilage/pathogenic microorganisms and quality loss such as tough meat in most red meat and broiler carcasses as well as pale soft exudative (PSE) meat in pork and turkey carcasses. Poor chilling also negatively influences flavor, appearance, and processing efficiency. Currently, most birds are chilled in cold water (water immersion chilling, WIC) in the United States (U.S.) or cold air (air chilling, AC) in the European community (Kang and Kim, 2017). In WIC, broiler and turkey carcasses are usually immersed in a water tank for 1-2 hours and 4-5 hours, respectively, which provides an environment for cross-contamination and unnecessary heat shortening and cold shortening in the extended chilling time.

Previously, our laboratory demonstrated that sub-zero saline chilling (SSC) improved chilling efficiency, meat tenderness, and microbial reduction in Gram-positive bacteria (not total bacteria) (Kang and Hurley, 2019). More specifically, our laboratory observed that broiler chilling at 4% NaCl/−2.41° C. resulted in the good outcomes in bacterial reduction, meat tenderness, and processing efficiency after various tests from 0% NaCl/0.5° C. to 8% NaCl/−5.08° C., with the potential for saving potable (or drinkable) water usage and reducing wastewater generation (Kang and Hurley, 2019; Kang et al., 2018; Metheny, 2018; Metheny et al., 2019). In addition, similar results were observed when broiler carcasses were chilled in post-chilling tank only, compared to the carcasses chilled in pre- and post-chilling tanks.

Subzero saline chilling has previously been described by the inventor as set forth in US Patent Application 20190008174. The contents of that application are incorporated herein by reference in its entirety. In brief, the process utilizes immersing an animal carcass in at least one saltwater solution, where the salt content of the water is from about 1% (w/v) salt/water to about 10% (w/v) salt/water and providing the temperature of the saltwater solution is from about 0.6° C. to about 6.0° C.

Previously, broiler carcasses have been chilled in 5% saline solution at −1° C. or ice slush at 1° C. for overnight, resulting that the carcasses in saline solution have more tenderized meat, better moisture content, higher cooking yield, and higher sensory attributes than in ice slush (Janky et al. 1978). However, the saline chilling has been chilled overnight at −1° C. that is not ideal to current poultry processors especially with higher water absorption. Similar results were observed in broiler carcasses chilled in 5% NaCl brine solution at −1 to 2° C. for 4 to 24 h (Carpenter et al., 1979; Hoey et al., 1983). Using hot boned beef striploins (take meats before carcass chilling), Anita et al (2017) reported that immediate chilling at −20° C. water bath (45% propylene glycol) improved meat tenderness at 2-day post-mortem that was obtained by accelerating tenderization early via a combined effect of biochemical and biophysical factors. Single and combined agents of propylene glycol (PG; 5, 10, and 20%) and lactic acid (LA; 0.25 and 0.5%) were evaluated on Salmonella decontamination on broiler carcasses that were chilled with PG and/or LA at 0 to 1° C. The two (0.25% LA+20% PG and 0.5% LA+20% PG) out of 12 treatments completely eliminated Salmonella from the carcasses, but with color and odor issues on the carcasses (Izat et al., 1990). Hot water spray (HWS) on broiler carcasses before chilling reduced about 1 log unit in mesophilic aerobic bacteria (MAB) and lowered the prevalence of Salmonella although not true for Campylobacteria. (Zhang et al., 2013; Cox et al., 1974; James et al., 2007). The exposure of HWS at 71° C. for 1 min, however, induced partially cooked appearance on the carcass while exposure at 60° C. for 10 min showed no adverse effect on carcasses appearance (Morrison and Fleet, 1985). There are many publications regarding saline chilling (at −1° C. or higher), rapid chilling (in propylene, nitrogen, or cold air), and hot water spray (at 71 or 60° C.) on carcasses to improve product safety and quality. However, these types of applications showed weak results with negative side effects such as undesirable color, flavor, absorption, and extended time.

### SUMMARY

The present methods provide for contacting an animal carcass with hot water at a temperature of about 50° C. to about 90° C. for about 0.1 minutes to about 10 minutes and immersing the carcass in at least one water solution at a temperature of about −0.6° C. to about −6.0° C. The methods provided are able, in embodiments, to reduce contamination from microbial sources such as bacteria, improve tenderness of the resulting meat product, and enhance processing efficiency by decreasing cost, water usage, wastewater output, time and energy necessary for processing meat carcasses.

### DESCRIPTION OF THE FIGURES

The following drawings form part of the specification and are included to further demonstrate certain embodiments or various aspects of the invention. In some instances, embodiments of the invention can be best understood by referring to the accompanying figures in combination with the detailed description presented herein. The description and accompanying figures may highlight a certain specific example, or a certain aspect of the invention. However, one skilled in the art will understand that portions of the example or aspect may be used in combination with other examples or aspects of the invention.

FIG. 1 shows temperature profiles of broiler fillets during chilling in water and brine solutions.

FIG. 2 shows effects of broiler chilling temperature and salt content on shear force (physical force required to cut a piece of meat) of broiler fillets.

FIG. 3 shows quantitative microbiome profiles after four different treatments.

FIG. 4 show quantitative microbiome profiles for Gram-positive bacteria and Gram-negative bacteria after four different treatments.

### DETAILED DESCRIPTION

The present methods utilize hot water spray (HWS) contact with the carcasses in addition to subzero saline chilling (SSC). The subzero saline chill may also be carried out for a shorter time period (i.e., pre-chill only) than had previously been utilized to yet achieve results of shear force reduction, reduction in bacteria and cost reduction. After the shorter time periods in subzero saline chilling, in an embodiment the carcass can be chilled continuously in ice water without saline (i.e., post-chill) if reduced salt usage is desired. The present methods (combination of hot water spray and subzero saline chilling) achieved the surprising result of increasing reduction in bacteria to a synergistic degree. What is expected is a one log or less reduction in bacteria, yet what is achieved is at least a two-log reduction. In embodiments the reduction in bacteria is more than one log, and can be two log, three log, four log, five log, six log, or amounts in-between. Embodiments provide that Gram-negative and Gram-positive bacteria are reduced. It is believed without being bound to such theory that the hot-water temperature (heat) kills or damages heat-labile bacteria, the subzero temperature (chilling) kills or damages cold-labile bacteria, and the saline (salt) kills or damages salt-labile bacteria. Further the heated water kills Gram-positive bacteria whereas subzero chilling kills Gram-negative bacteria including Salmonella and Escherichia coli (E. coli). Still further, it is found the hot water cleans the bird carcasses before exposure to the chilled water and as a result the chilled water (or red water if used in carcass-chilling previously) can be used repeatedly. The saltwater also stays cleaner longer than when hot water is not used, providing for a longer useful life of the stale water and reduction in waste stream problems due to less bacterial growth. The application as described here of hot water temperature and time does not give negative defects in appearance such as partially cooked color when the carcasses were rapidly chilled in subzero solutions. A concern is that any over-heat can cook the meat, especially to a point where the skin and meat will change the color from its raw state to a partially cooked appearance with grey color.

### Definitions

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

It is to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Similarly, the word “or” is intended to include “and” unless the context clearly indicate otherwise. The word “or” means any one member of a particular list and also includes any combination of members of that list. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4%. This applies regardless of the breadth of the range.

The term “about,” as used herein, refers to variation in the numerical quantity that can occur, for example, through typical measuring techniques and equipment, with respect to any quantifiable variable, including, but not limited to, mass, volume, percent change, time, and temperature. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The methods and compositions of the present invention may comprise, consist essentially of, or consist of the steps, components and ingredients of the present invention as well as other ingredients described herein. As used herein, “consisting essentially of” means that the methods, systems, apparatuses, and compositions may include additional steps, components or ingredients, but only if the additional steps, components or ingredients do not materially alter the basic and novel characteristics of the claimed methods, systems, apparatuses, and compositions.

“Poultry” includes any fowl or bird, and includes, and by way of example without limitation, chickens, turkeys, geese, capon, cornish hens, squab, ducks, guinea, fowl, and pheasants.

“Carcass” is intended to cover whole slaughtered animals (such as a chicken) as well as parts. In an embodiment, the carcass is that of an animal that has been slaughtered.

As used herein, “(w/v)” means weight to volume. For example, grams to liters. When expressed as a percentage, the ratio is calculated by multiplying ratio of weight/volume by 100. For example, 1% saltwater could be produced by dissolving 10 grams of salt in 1 liter (1000 mL) of water. (10/1000×100=1)

There are many unexpected advantages to the process. Bacterial contamination was reduced on broiler carcasses due to the synergistic effects of hot water (heat-sensitive bacteria reduction), cold water (Gram-negative bacteria reduction), and salt-water (salt-sensitive bacteria reduction). Meat was tenderized due to the reduction of heat shortening at 15-40° C. and cold shortening at ≤5-15° C. during the rapid chilling. Toughness occurs with cold shortening where temperature decline of the carcass exceeds pH decline and on the other hand heat shortening can occur where cooled slowly and muscle pH falls rapidly. Similar results of bacterial reduction and meat tenderization are expected after HWS and SSC in pre-chilling only, followed by traditional post-chilling in ice slurry solution. Usage of potable water and generation of wastewater is reduced due to the extended recycle of red water (the water after carcass chilling). Visual defects or partially cooked appearance on broiler carcasses are minimized after mild HWS and rapid cold-temperature exposures in the combination of HWS/SSC. Long term benefits include improved raw meat quality and protein functionality, and additional health benefits are achieved through the generation of low-sodium, low-oxidation, or no-phosphate meat products in sausage, restructured meat, enhanced meat, etc. Public health is improved due to the reduction of bacterial contamination on meat products.

In an embodiment of the process here, animal carcasses are exposed to hot water prior to exposure to sub-zero chilling as described below. The processes are carried out on an animal that has been slaughtered. Any animal that is slaughtered for meat may be used with the present processes. By way of example without limitation, the methods may be used where the animal is selected from ungulate; fowl; and fish; where the animal is cow; pig; elk; bison; deer; sheep; goat; turkey; chicken; salmon; tuna; or cod.

The present processes provide, inter alia, methods of producing a meat product comprising: a) contacting a carcass of an animal with hot water at a temperature of about 50° C. to about 90° C. for about 0.1 minutes to about 10 minutes; and b) immersing the carcass in at least one water solution at a temperature of about −0.6° C. to about −6.0° C.

Embodiments provide the hot water may be at a temperature from about 50° C. to about 90° C., from about 55° C. to about 85° C., from about 60° C. to about 80° C., or from about 65° C. to about 75° C. In a preferred embodiment the temperature is from about 65° C. to about 70° C. Embodiments provide the hot water may be at a temperature of about 65° C., about 66° C., about 67° C., about 68° C., about 69° C., about 70° C., about 71° C., about 72° C., about 73° C., about 74° C., or about 75° C. Embodiments provide the exposure of the carcass to such temperatures is from about 0.1 minutes to about 10 minutes, from about 0.25 minutes to about 10 minutes, from about 0.5 minutes to about 10 minutes, from about 0.75 minutes to about 10 minutes, from about 1 minute to about 10 minutes, about 0.1 minutes to about 5 minutes, from about 0.25 minutes to about 5 minutes, from about 0.5 minutes to about 5 minutes, from about 0.75 minutes to about 5 minutes, from about 1 minute to about 5 minutes, about 0.1 minutes to about 2 minutes, from about 0.25 minutes to about 2 minutes, from about 0.5 minutes to about 2 minutes, from about 0.75 minutes to about 2 minutes, from about 1 minute to about 2 minutes. Preferred embodiments provide the exposure is from about 0.1 minutes to about 5 minutes. Embodiments provide the exposure of the carcass to such temperatures for about 0.1 minutes, about 0.25 minutes, about 0.5 minutes, about 0.75 minutes, about 1 minute, about 2 minutes, about 3 minutes, about 4 minutes, about 5 minutes, about 6 minutes, about 7 minutes, about 8 minutes, about 9 minutes, or about 10 minutes. In one example, carcasses were exposed to hot water spray at 71° C. for 1 min prior to the sub-zero saline chilling (SSC) at 4% NaCl/−2.41° C.

When referring to a hot water spray, a spray of water at such temperatures is used in a preferred embodiment. However, the hot water can be applied in any convenient form, such as immersion, washing, dipping, steam exposure or the like. Spray can be useful in minimizing potable (drinkable) water and wastewater by cleaning the carcasses before chilling.

In a preferred embodiment, the carcass is placed in the chilled saline water immediately after being slaughtered and after contacting the carcass of an animal with the hot water, but before the time in which rigor mortis develops or when the meat is still in pre-rigor condition. Allowance may also be made after slaughter for optional processing such as stunning, bleeding, scalding, dehairing, torching, evisceration, USDA inspection, washing and chilling with/without pre-chilling. The time involved prior to immersion in the saline water will be dependent upon these optional steps employed and the setup of the processing facility and efficiency. By way of example, without limitation, poultry and fish in an embodiment can be immersed in the chilled saltwater 10 to 25 minutes postmortem, pork, goat, and lamb immersed 25 to 45 minutes postmortem and beef, buffalo, and yak immersed 30 to 60 minutes postmortem.

Chilling of carcasses in a sub-zero saline solution improves processing efficiency, meat quality, product safety, sensory attributes, and overall processing cost. An embodiment provides that use of the subzero chilling solution results in increased chilling efficiency than use of solutions in above-zero or warmer temperatures. For example, using the subzero chilling solution, and chilling for 45 to 60 minutes is more efficient than traditional steps such as chilling for 80 to 140 minutes in an ice slurry of 1° C. to 4° C.; or where using two chilling steps, such as pre-chilling at 5 to 30° C. followed by post-chilling at 1° C. to 4° C. for total chilling time of 60 to 150 minutes. Thus, with the process, less energy is used, and more carcasses can be processed in the same amount of time. In an embodiment, the time for chilling the animal as a part of meat processing is reduced. An embodiment reduces the time by at least about 10, 15, 20, 25, 30, 35, 40, 45, 50, 55, 60, 65, 70, 75, 80, 85, 90, 95, 100, 105, 110, 115, 120, 125, 130, minutes to 135 minutes or more; and in further embodiments reduces the time by at least 5%, 10%, 15%, 20%, 25%, 30%, 35%, 40%, 45%, 50%, 55%, 60%, 65%, 70%, 75%, 80%, 85%, 90%, or more.

By increasing the number of carcasses per gallon of chilling water, processors can reduce processing costs through higher chilling rate, lower water consumption, lower wastewater output, and more efficient energy usage. Furthermore, sub-zero chilling reduces bacterial attachments on carcasses due to skin shrinkage and lower bacterial activity than skin swelling and higher bacterial movement in water at ≥1° C.

Embodiments provided herein include any methods as described, wherein the temperature of the subzero water solution is in a range selected from the group of: from about −0.6° C. to about −6.0° C.; from about −1.0° C. to about −5.0° C.; from about −2.5° C. to about −5.0° C.; from about −2.5° C. to about −4.0° C.; and from about −3.0° C. to about −4.0° C. The temperature of the subzero water solution in an embodiment may be about −1.5° C., −2° C., −3° C., −4° C., −5° C., −6° C. or amounts in-between.

Embodiments provided include any methods as described, wherein the step b) is conducted for about 0.5 hour to about 4 hours; 1 hour to about 3 hours; for about 1.5 hour to about 2.5 hours; or about 2 hours. Embodiments provided include where step b) is conducted for about 0.5, 1, 2, 3, 4, hours or amounts in-between.

Embodiments provided herein include any methods as described, wherein step b) is conducted such that the finished product has a shear force (N) of from about 6 to 11; of from about 7.2 to about 8.5, or about 6, 7, 8, 9, 10, 11 or amounts in-between. Embodiments provided herein include any methods as described, which result in no significant difference in the absorption of solution (e.g., saltwater) during processing compared to similar processing in water alone. Embodiments provided herein include any methods as described, which result in no significant chilling yield (or solution absorption) increases compared to similar processing in water alone. Chilling yield refers to the increased weight of carcass that results at the end of the chilling process. Embodiments provided herein include any methods as described, which result in no significant salt content increases compared to similar processing in water alone.

An embodiment provides for adding salt to the chilling water as described, wherein the addition of salt does not increase the salt content of the meat after chilling or increases it 1% or less. Embodiments provided include any methods as described, wherein the percentage of salt in the saltwater is in a range selected from the group of: about 1% (w/v) salt/water to about 10% (w/v) salt/water; 1% (w/v) salt/water to about 9% (w/v) salt/water; 1% (w/v) salt/water to about 8% (w/v) salt/water; 1% (w/v) salt/water to about 7% (w/v) salt/water; 1% (w/v) salt/water to about 6% (w/v) salt/water; 1% (w/v) salt/water to about 5% (w/v) salt/water; 1% (w/v) salt/water to about 4% (w/v) salt/water; 1% (w/v) salt/water to about 3% (w/v) salt/water; and 1% (w/v) salt/water to about 2% (w/v) salt/water. The percentage of salt in the saltwater in an embodiment can be about 1%, 2%, 3%, 4%, 5%, 6%, 7%, 8%, 9% or 10% or amounts in-between.

An embodiment provides for a subzero water solution comprising propylene glycol and no salt. No labeling of “tenderized with salt” is required if the meat is tenderized by propylene glycol in sub-zero temperature, indicating that the meat was tenderized by sub-zero temperature rather than salt.

Also provided are methods to produce a meat product, wherein the salt content increase is 1% or less, has less than 0.16%, or is not increased comprising: a) contacting a carcass of an animal with hot water at a temperature of about 50° C. to 90° C. for about 0.1 minutes to about 10 minutes; and b) immersing the animal carcass in at least one saltwater solution at a temperature of about −0.6° C. to −6.0° C., wherein the percentage of salt in the water is in the range of from about 1% (w/v) salt/water to about 10% (w/v) salt/water, and wherein the temperature of the saltwater solution is in the range of from about −0.6° C. to about −6.0° C.; and chilling the animal carcass and producing a meat product in which there is 1% or less, less than 0.16% or no increase in salt content and any increase in salt content in the chilled carcasses can be removed by further processing. Current commercial methods typically do not add salt to the chilling water, where here salt is added. The inventors have found that salt in the water is not absorbed by the muscle of the carcasses during chilling. Some salt solution can be trapped between the skin and meat, but can be eliminated during further processing, such as when cutting, deboning meat, or de-skinning for example.

Further, an embodiment provides for chilling the carcass more quickly. In an embodiment the animal is taken from body temperature following slaughter (body temperature being the temperature of the animal at the time of slaughter, generally about 40° C., and some birds having temperature about 40.6° C.) to at or less than 5° C. using the subzero temperatures described here of −0.6° C. to −6.0° C. The amount of time will vary depending on the size of the carcass but can be reduced rapidly compared to a process not using salt and the subzero temperatures by about 5%, 10%, 20%, 25%, 30%, 35%, 40%, 45%, 50%, 55%, 60%, 65%, 70%, 75%, 80%, 90%, 95% or more and amounts in-between. Preferred embodiments provide the time of cooling compared to a process not using salt and the subzero temperatures described here is reduced by 15% to at least 50%, and in other embodiments 15% to 25%. For example, the time to reduce the temperature of chicken from the near live body temperatures (typically a live chicken has a temperature of 105° to 107° F./40.5° C.-41.6° C. for example) to 5° C. or less, in an example to about 4.4° C. to 4.7° C. is about 22% and to reduce the temperature of a turkey carcass from about 43° C. to about 4.4° C. can be reduced by 46% to about 58%. Embodiments provide the animal is taken from body temperature to about 4.4° C. and then the chilling process stopped. Still further embodiments provide total chilling time of broiler carcasses is 1.5 to 2.0 hours.

Also provided are methods to improve tenderness in a finished fresh product comprising: a) contacting a carcass of an animal with hot water at a temperature of about 50° C. to about 90° C. for about 0.1 minutes to about 10 minutes; and b) immersing the carcass in at least one water solution at a temperature of about −0.6° C. to about −6.0° C.; and chilling the carcass, thereby enhancing tenderness in the finished product.

The methods provide for increased tenderness as measured by shear force values, where the shear force is reduced compared to a process that does not use subzero saline chilling. In embodiments the decrease in toughness/shortening or shear force is by at least 5%, 10%, 15%, 20%, 25%, 30%, 35%, 40%, 45%, 50%, 55%, 60%, 65%, 70%, 75%, 80%, 85%, 90%, or more.

Also provided are methods to reduce bacterial population during meat production, comprising: a) contacting a carcass of an animal with hot water at a temperature of about 50° C. to about 90° C. for about 0.1 minutes to about 10 minutes; b) immersing the carcass in at least one water solution at a temperature of about −0.6° C. to about −6.0° C.; and c) producing the meat product from the carcass, wherein the meat product has decreased bacterial content compared to a method in which the carcass is not contacted with the hot water and chilled using subzero saline solution. Additional embodiments provide for decreasing bacteria on the carcass, including a decrease in both Gram-positive and Gram-negative bacteria.

Also provided are methods of reducing bacteria of a water solution used in meat processing, the method comprising: a) contacting a carcass of an animal with hot water at a temperature of about 50° C. to 90° C. for about 0.1 minutes to about 10 minutes; and b) immersing the animal carcass in at least one water solution at a temperature of about −0.6° C. to −6.0° C., wherein the water solution has fewer bacteria after immersion of the carcass than when the carcass is not first contacted with the hot water.

Also provided are methods to reduce potable water use, reduce wastewater output during meat production, reduce the overall time and cost for processing during meat production, reduce energy use by the methods outlined.

Less water is used in the present process than in traditional processes. Here, chilling efficiency results from cold temperatures. By way of example, without limitation, if it is possible to chill ten carcasses such as poultry per hour in subzero cold water instead of five poultry per hours in an ice slurry, it can allow for reducing chilling water by 50%. Recycling of subzero water and ice slurry solutions are also extended due to the chilling of clean carcasses (after HWS) in the pre- and post-chilling tanks and less bacteria growth the subzero saline solution, without the use of an antibacterial chemical or disinfectant (chlorine, peracetic acid, etc).

Usage of potable water and generation of wastewater is reduced due to the extended recycle of red water (the water after carcass chilling). The reduction in water used and costs can be 10%, 20%, 30%, 40%, 50% 60%, 70%, 80%, 90% or more in an embodiment. In an embodiment the water may be reused one, two, three, four times or more.

Embodiments provided herein include any methods as described, which result in no significant cooking yield increases compared to similar processing in water alone. Embodiments provided herein include any methods as described, which result in no significant pH change compared to similar processing in water alone. Such processes may be conducted as steps of a larger meat processing strategy characterized by a serious of killing and processing steps. Other optional steps which may be employed in a meat processing strategy include a hanging step before or after killing, bleeding, hot-water immersing (scalding) and/or skinning or plucking or hollowing/eviscerating. A chilling step (via the methods described herein) is performed either in succession or simultaneously. Further optional steps may include a succeeding cutting-up/marinating/dispensing/packaging process, distribution to end users, cooking, and eating.

References cited herein are incorporated by reference. The following examples are intended for exemplification and not to limit the scope of the invention.

### EXAMPLES

Recently, subzero saline chilling as described here of carcasses at 4% NaCl/−2.4° C. significantly improved meat chilling efficiency, meat tenderness, and bacterial reduction except the population of mesophilic aerobic bacteria or total bacteria (Kang et al., 2019). This inventive study further improves the effects of subzero saline chilling by applying hot water spray (at 65° to 71° C.) prior to chilling. The combination of HWS and subzero saline chilling resulted in significant bacterial reduction including total bacteria with chilling efficiency and meat tenderness. It is also inventor's belief that the HWS will clean the carcasses so that the red water can be used for an extended time compared to the control red water with no HWS. Where one chilling tank only is used the industry refers to this as “one tank” chilling or “one entire tank” chilling. Where two tanks are used, the first is referred to as “pre” chilling and the second tank referred to as “post” chilling. In addition, it is possible to chill broiler carcasses using one of three chilling methods: 1) sub-zero saline chilling in pre-chilling tank (15-30 min) followed by traditional ice water chilling in post-chilling tank (45-80 min), 2) ice water chilling in pre-chilling tank (15-30 min) followed by sub-zero saline chilling in post chilling tank (30-80 min), or 3) sub-zero saline chilling in one chilling tank (60-100 min).

Below by way of example is a comparison of one embodiment of the process compared to prior methods:
1. Traditional commercial method one: Using one tank for 1-2 hours (also referred to here as an entire chilling tank).
2. Traditional commercial method two: Using two tanks for pre-chilling (15-30 min) and post-chilling (45 min to 1 hour 45 min).
3. Previously tested methods:
   First, using one entire sub-zero saline chilling tank.
   Second, using two tanks for pre-chilling for 25 min with ice slurry+post chilling for 1-1.25 h in sub-zero saline solution. We found a similar trend in both chilling methods.
4. Testing by present method: HWS+one entire sub-zero saline chilling tank which can be HWS for 1 minute and SSC for 55 minutes.
5. Alternative present methods: HWS+pre-chilling in sub-zero saline solution+post-chilling with ice slurry.

As a result, the amount of salt can be reduced significantly while the absorbed salt in the skin can be washed as close as control birds in the end of next post-chilling in water.

In this experiment, the following sequential three-step approach was utilized as follows with (1) improvement of chilling time and fresh meat tenderness, (2) microbial safety, and (3) reduction of water consumption, waste management and operational cost.

### 1^{st} Step—

A total of 32 broilers (4 birds/treatment for 2 replications) were conventionally slaughtered, eviscerated, and subjected to one of the four chilling methods:
1. Water immersion chilling (WIC) 0% NaCl chilling at 0.5° C.
2. Sub-zero saline chilling (SSC) 4% NaCl chilling at −2.4° C.
3. Hot water spray (HWS)/WIC 0% NaCl chilling at 0.5° C. after HWS at 71° C. for 1 min
4. HWS/SSC 4% NaCl chilling at −2.4° C. after HWS at 71° C. for 1 min

### Results

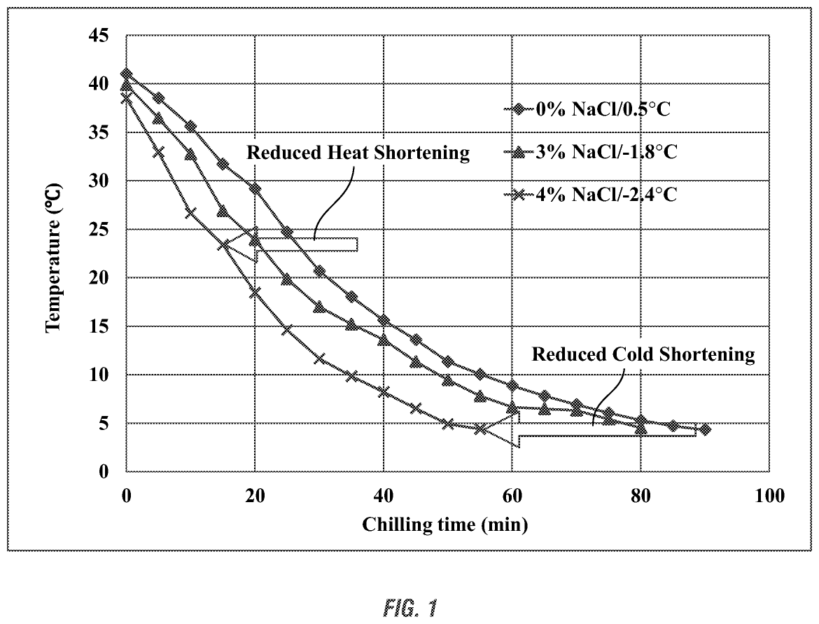

During chilling of broiler carcasses, using three chilling methods (without hot water spray), the internal temperatures of eviscerated carcasses continuously reduced from 40° C. to 4.3-4.5° C. in 90, 80, and 55 min in 0% NaCl/0.5° C., 3% NaCl/−1.8° C. and 4% NaCl/−2.4° C. solutions, respectively (FIG. 1). Compared to the water control (0% NaCl/0.5° C.), 3% NaCl/−1.8° C. and 4% NaCl/−2.4° C. chilling solutions reduced the chilling time by 11% and 37%, respectively. The results in FIG. 1 show the improvement of chilling efficiency by reducing the carcass temperatures as the salt concentration increased and the chilling temperature decreased.

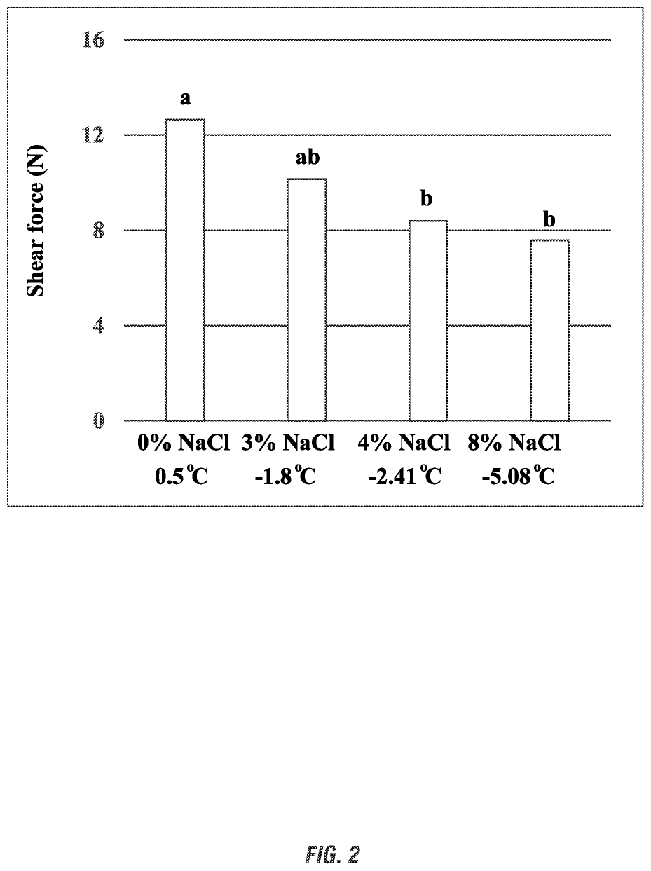

Breast fillets from the carcasses in 4% NaCl/−2.4° C. solution showed significantly lowered shear force (8.4 N) than those (12.64 N) of broilers in water control, with the intermediate (10.15 N) observed in 3% NaCl/−1.8° C. solution (FIG. 2). The results in FIG. 2 indicate the improvement of meat tenderness with the reduction of shear force (physical force required to cut a piece of meat) as the salt content increased and the chilling temperature decreased.

These results of meat tenderness were supported by sarcomere lengths (the distance between one z-line and the next z-line in muscle structure) that were significantly longer in sub-zero saline solutions than those in water solution (Table 1). This result indicated that less muscle fibers need to be sheared or cut in the muscle with longer sarcomere length (tender meat) than the muscle with shorter sarcomere length (tough meat). No significant difference was found for pH (status of lactic acid accumulation) and R-value (status of ATP broken down) except the R-value in water control (Table 1).

Table 1 shows evaluation of pH, R-value, and sarcomere length after chilling carcasses in three different chilling solutions.

TABLE 1

| | 0% NaCl/ | 3% NaCl/ | 4% NaCl/ |
|---|---|---|---|
| Chilling | 0.5° C. | −1.8° C. | −2.4° C. |
| pH | 5.94^{a} | 5.80^{a} | 5.80^{a} |
| R-value | 1.12^{b} | 1.38^{a} | 1.40^{a} |
| Sarcomere length | 1.57^{b} | 1.9^{a} | 2.02^{a} |
| (μm) | | | |

^{a-b}Means within a row with no common superscripts are different (P < 0.05).
¹Number of observation, n = 4

In order to minimize carcass contamination, poultry processing plants have used various chemicals such as chlorine, trisodium phosphate, ozone, and organic acids during carcass washing and chilling (Fabrizio et al., 2002; James et al., 2006; Møretrø, 2012). For the last 20 to 30 years, however, the incidence of human foodborne illness from Salmonella has remained unchanged, and Campylobacter is one of the most commonly identified sources of bacterial foodborne illness in the United States (Scallan et al., 2011). Having a significant bacterial reduction in the carcasses in HWS/SSC compared the carcasses in the control or traditional ice chilling, it will be an additional advantage if anti-bacterial chemicals and disinfectants are not used. Current consumers do not like their products with chemicals, and the European Union prohibited water chilling due to more cross-contamination on carcasses without chlorine and the link to carcinogenesis with chlorine usage (Sams, 2001; Thomas, 1977; Thomas et al., 1974).

Before chilling, the skin of broiler carcass naturally possessed mesophilic aerobic bacteria (MAB), Escherichia coli (E. coli), and total coliforms for 3.81, 0.78, and 1.86 log cfu/g, respectively, which were significantly reduced when the carcasses were chilled in 3% NaCl/−1.8° C. or 4% NaCl/−2.41° C. over the water control (P<0.05), except the MAB (Table 2). The combination of sub-zero temperatures and unfavorable condition of 4% NaCl/−2.41° C. can induce a synergistic effect and reduce the bacterial populations on carcasses in subzero saline solutions. During the carcass chilling in sub-zero saline solutions, bacterial activity and their attachment to carcasses are expected to drop to a minimal level due to less skin swelling in sub-zero temperatures. It has been reported that traditional chilling of broiler carcasses caused skin swelling due to water absorption, which aided the opening of deep crevices and channels on the skin surface for more bacterial attachment and penetration (Singh et al., 2017; Sing et al., 2015; Thomas and McMeekin, 1982).

Table 2 shows mean population (log cfu/g) of mesophilic aerobic bacteria (MAB), total coliforms, and Escherichia coli (E. coli) on broiler skin after chilling.

TABLE 2

| | Before chilling | After chilling | | |
|---|---|---|---|---|
| | None | 0% NaCl/0.5° C. | 3% NaCl/−1.8° C. | 4% NaCl/−2.4° C. |
| MAB | 3.81^{a} (0.09)* | 3.62^{ab} (0.13) | 3.49^{ab} (0.14) | 3.34^{b} (0.15) |
| Total coliforms | 1.86^{a} (0.12) | 1.34^{b} (0.15) | 0.37^{c} (0.12) | 0.63^{c} (0.13) |
| E. coli | 0.78^{a} (0.20) | 0.60^{a} (0.13) | 0.02^{c} (0.02) | 0.23^{c} (0.09) |

^{a-c}Means within a row with no common superscripts are different (P < 0.05).
Number of observation, n = 16.
*SE, standard error.

In a continuous study, broiler carcasses were chilled using the control (0% NaCl/0.5° C.) and 4% NaCl/−2.4° C. solutions with/without hot water spray at 71° C. for 1 min. The study indicated that the skin of prior-chilled broiler carcasses naturally possessed MAB, E. coli, and Salmonella for 4.7 cfu/g, 2.6 log cfu/g, and 100% prevalence, respectively (Table 3). The combination of HWS (71° C./1 min) and SSC (4% NaCl/−2.4° C.) significantly reduced MAB and Gram-negative bacteria on broiler carcasses more than any single treatment or no treatment control (Table 3). A similar application of hot-water spray (71° C. for 1 min) and WIC on broiler carcasses significantly reduced MAB but not Campylobacteria over WIC control (Zhang et al., 2013). Both reductions of MAB and Gram-positive bacteria after the exposure of HWS/SSC were expected from the combined effects of hot water for psychotropic bacteria, sub-zero temperature for Gram-negative bacteria, and saline solution for salt-sensitive bacteria.

Table 3 shows mean populations (log CFU/g) of mesophilic aerobic bacteria (MAB) and Escherichia coli (E. coli) as well as prevalence of Salmonella on the chicken skin receiving different chilling methods.

TABLE 3

| Chilling | WIC | SSC | HWS/WIC | HWS/SSC |
|---|---|---|---|---|
| MAB | 4.70^{a} | 4.19^{ab} | 3.66^{b} | 2.54^{c} |
| E. Coli | 2.60^{a} | 1.78^{b} | 2.01^{ab} | 0.18^{c} |
| Total Coliforms | 2.61^{a} | 2.12^{a} | 1.91^{a} | 0.87^{b} |
| Salmonella | 100 (4/4)^{a} | 0 (0/4)^{b} | 100 (4/4)^{a} | 0 (0/4)^{b} |

^{a-c}Means within a column without common letters are differet (P < 0.05)
WIC—water immersion chilling; HWS—hot water spray; SSC—subzero saline chilling 4% NaC1/−2.41° C.

To investigate the changes in bacterial population on chicken carcasses after the 4 treatments (WIC, SSC, HWS/WIC, and HWS/SSC), we performed 16S rRNA gene profiling analysis using the pool of bacterial colonies recovered on PETRIFILM™ APC films. For preparation of 16S rRNA gene sequencing library, V4 region of 16S rRNA gene from the genomic DNA (2 sample for each treatment group) was amplified according to the protocol used for the Earth Microbiome project (earthmicrobiome.org). The amplicons from each sample were pooled together, gel-purified and sequenced with Illumina MiSeq platform with paired end 250 cycle options.

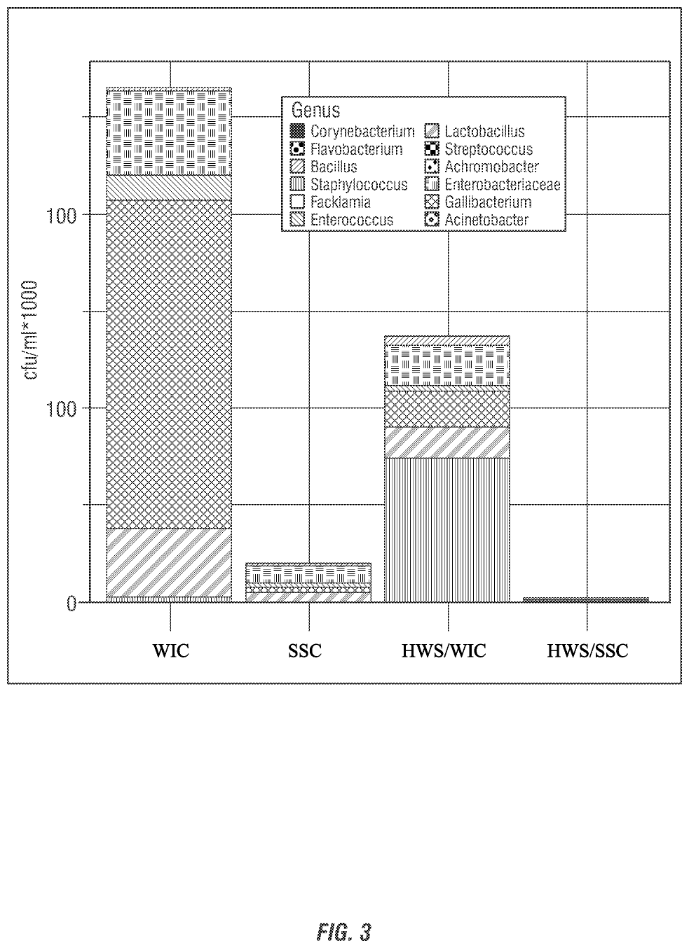

The raw sequence reads were processed using QIIME 2 version 2018.8 (Bolyen et al. 2018) with Deblur plugin (Amir et al. 2017). Taxonomic assignment was performed using a Naive Bayes classifier pre trained with Greengenes (Version 13.8) at 99% cutoff level for OTUs (DeSantis et al., 2006). The resulting microbiome profile based on relative abundance is shown in FIG. 3. The results show that the WIC showed various types of microbiome profiles, followed by HWS/SSC, SSC, and HWS/SSC. The 4 treatments may have varying levels of bactericidal activity against different genera present on chicken carcasses.

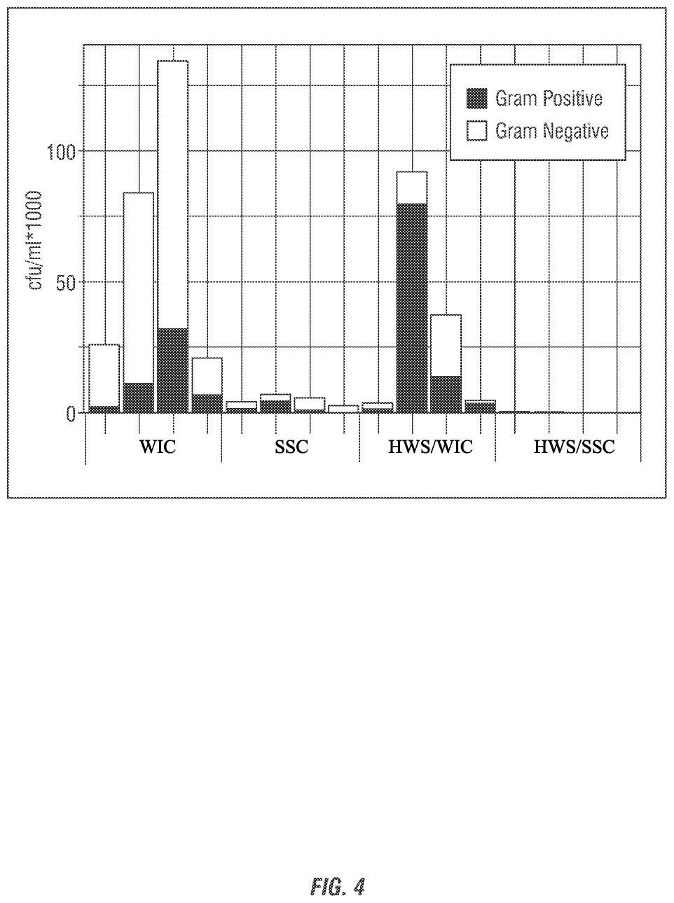

The relative abundance information for each genus was calibrated using the CFU/g data of the carcass rinse (MAB, Table 1) to generate quantitative microbiome profiles as shown in Table 3. The results of FIG. 3 indicate that WIC showed viable bacteria of different genera present at the highest level, followed by HWS/WIC, SSC, and HWS/SSC. Interestingly, the combination of HWS and SSC completely eliminated Gram negative bacteria with a trace amount of Gram-positive bacteria while no or single treatment failed to show a sufficient elimination of Gram negative bacteria in HWS/WIC, Gram positive bacteria in SSC/WIC, and Gram negative/positive bacteria in WIC control (FIG. 4).

Analysis of the Microbiotas Using High-Throughput Sequencing of 16S rRNA Gene

We will perform 16S rRNA gene microbiome profiling for the treatment groups as briefly described in the above studies. In addition to the bacterial populations recovered on APC pertifilms, we will also include DNA samples directly extracted from the carcass rinses before and after the treatments for 16S rRNA gene microbiome analysis. For the statistical power of the analysis, we will include at least 8 samples for each treatment group, and perform in-depth analysis of the sequencing data, including alpha and beta diversity, taxonomic analysis, and PERANOVA analysis (Anderson 2001).

### 2^{nd} Step—

We will evaluate the best combination of HWS/SSC that will result in significant bacterial reduction, no/minimal visual defects after HWS, and no/minimal salt absorption after chilling (pre-/post-SSC chilling) or pre-SSC chilling only.

### 3^{rd} Step—

We will evaluate the effects of sub-zero chilling on broiler meat tenderness using propylene glycol (not salt) to eliminate the requirement of labeling of “tenderized with salt”. No labeling of “tenderized with salt” will be required if the meat is tenderized by propylene glycol in sub-zero temperature, indicating that the meat was tenderized by sub-zero temperature, not by salt.

### REFERENCES

Amir, A., McDonald, D., Navas-Molina, J. A., Korylova, E., Morton, J. T., Zech, X. Z., Kightley, E. P., Thompson, L. R., Hyde, E. R., Gonzalez, A., and Knight, R. (2017) Deblur rapidly resolves ingle-nucleotide community sequence patterns. mSystems. e00191-16. doi: 10.1128/mSystems.00191-16.
Anderson, M. J. (2001). Permutation tests for univariate or multivariate analysis of variance and regression. Can. J. Fish Aquat Sci. 58, 626-639.
Bolyen, E., Rideout, J. R., Dillon, M. R., Bokulich, N. A., Abnet, C., Al-Ghalith, G. A., Alexander, H., Alm, E. J., Arumugam, M., Asnicar, F., et al. (2018). QIIME 2: Reproducible, interactive, scalable, and extensible microbiome data science. PeerJ Preprints, e27295v1.
Carpenter, M. D., D. M. Jankey, A. S. Arafa, J. L. Oblinger, and J. A. Koburger. 1979. The effect of salt brine chilling on driploss of ice packed broiler carcasses. Poult. Sci. 58:369-371.
Cox, N. A., A. J. Mercuri, B. J. Juven, J. E. Thomson, and V. Chow. 1974. Evaluation of succinic acid and heat to improve the microbiological quality of poultry meat. J. Food Sci. 39:985-987.
DeSantis, T. Z., Hugenholtz, P., Larsen, N., Rojas, M., Brodie, E. L., Keller, K., Huber, T., Dalevi, D., Hu, P., and Andersen, G. L. (2006). Greengenes, a chimera-checked 16S rRNA gene database and workbench compatible with ARB. Appl. Environ. Microbiol. 72, 5069-5072. doi:10.1128/AEM.03006-05
Fabrizio, K. A., R. R. Sharma, A. Demirci, and C. N. Cutter. 2002. Comparison of electrolyzed oxidizing water with various antimicrobial interventions to reduce Salmonella species on poultry. Poult. Sci. 81:1598-1605.
Hoey, J. M., M. G. Dukes, and D. M. Janky. 1983. Tenderness and sodium-content of pectoralis superficialis from broilers chilled in potassium or sodium chloride ice slush. J. Food Sci. 48:675-676.
Izat, A. L., R. E. Hierholzer, J. M. Kopek, M. H. Adams, J. P. McGinnis, and M. A. Reiber. J. Food Processing and Preservation. 14:369-374.
Janky, D. M., A. S. Arafa, J. L. Oblinger, J. A. Koburger, and D. L. Fletcher. 1978. Sensory, physical, and microbiological comparison of brine-chilled, water-chilled, and hot-packed (no chill) broilers. Poult. Sci. 57:417-421.
James, C., S. J. James, N. Hannay, G. Purnell, C. Barbedo-Pinto, H. Yaman, and M. Araujo., M Gonzalez, L., J. Calvo, M. Howell, and J. E. L. Corry. 2007. Decontamination of poultry carcasses using steam or hot water in combination with rapid cooling, chilling or freezing of carcass surfaces. Int. J. Food Microbiol. 114:195-203.
James, C., C. Vincent, T. I. de Andrade Lima, and S. J. James. 2006. The primary chilling of poultry carcasses—A review. Int. J. Refrig. 29:847-862.
Kang, I. and S. P. Hurley. Meat processing methods. US 2019/0008174 A1.
Kang, I. and Kim, Y. H. B. 2017. Enhancing texture and tenderness in poultry meat. Pages 291-319 in Achieving Sustainable Production of Poultry Meat. S. C. Ricke, ed. Burleigh Dodds Science Publishing, Philadelphia, Pa.
Kang, I., Metheny, M. M., Lee., H. C., Bennett, D. and Hurley, S. 2018. Improvement of chilling efficiency, product quality of broiler carcasses using sub-zero saline solutions. Proceedings. 2018 Midwest Poultry Federation (MPC) Convention. Minneapolis Convention Center, Minneapolis, Minn.
Kim, S. A., Park, S. H., Lee, S. I., Owens, C. M., and Ricke, S. C. (2017) Assessment of chicken carcass microbiome responses during processing in the presence of commercial antimicrobials using a next generation sequencing approach. Scientific Reports, 7:43354.
Metheny, M. M. 2018. Improvement of chilling efficiency and product quality of broiler carcasses using sub-zero saline solutions for chilling. Master's Theses. Department of Animal Science. California Polytechnic State University. San Luis Obispo. Calif.
Metheny, M. M., Lee, H. C., Viliani, S., Bennett, D. C., Hurley, S., and Kang, I. 2019. Improvement of chilling efficiency and meat tenderness of broiler carcasses using subzero saline solutions. Poult. Sci. 98:4190-4195.
Møretrø, T., E. Heir, L. L. Nesse, L. K. Vestby, and S. Langsrud. 2012. Control of Salmonella in food related environments by chemical disinfection. Food Res. Int. 45:532-544.
Sams, A. R. 2001. First processing: Slaughter through chilling. Pages 19-34 in Poultry Meat Processing. A. R. Sams, ed. CRC Press LLC, Boca Raton, Fla.
Scallan E., Hoekstra, R. M., Angulo, F. J., Tauxe, R. V., Widdowson, M. A., Roy, S. L., Jones, J. L. and Griffin, P. M. 2011. Foodborne illness acquired in the United State—major pathogens. Emerg Infect Dis. 17:7-15.
Sikes, A. L., R. Jacob, B. D'Arcy, and R. Warner. 2017. Very fast chilling modifies the structure of muscle fibers in hot-boned beef loin. Food Research International 93: 75-86.
Thomas, N. L. 1977. The continuous chilling of poultry in relation to EEC requirements. Int. J. Food Sci. Technol. 12:99-114.
Thomson, J. E., W. K. Whitehead, and A. J. Mercuri. 1974. Chilling poultry meat—a literature review. Poult. Sci. 53:1268-1281.
Zhang, L. P. Singh, H. C. Lee, and I. Kang. 2013. Effect of hot water spray on broiler carcasses for reduction of loosely attached, intermediately attached, and tightly attached pathogenic (Salmonella and Campylobacter) and mesophilic aerobic bacteria. Poul. Sci. 92:804-810.

What is claimed is:

1. A method of producing a meat product comprising:
a) contacting a carcass of an animal with hot water at a temperature of about 50° C. to about 90° C. for about 0.1 minutes to about 10 minutes;
b) immersing the carcass in at least one water solution at a temperature of about −0.6° C. to about −6.0° C.; and
c) producing the meat product from the carcass, wherein the meat product has decreased bacterial content and/or decreased shortening of the meat compared to a method in which the carcass is not contacted with the hot water.

2. The method of claim 1, wherein the hot water and/or the water solution have a salt content comprising about 1% to 10% salt weight per volume.

3. The method of claim 1, wherein no salt is added to the animal carcass.

4. The method of claim 1, wherein the meat product does not have increased salt content after contact with the hot water and the at least one water solution.

5. The method of claim 1, wherein the hot water is delivered by spraying the animal carcass.

6. The method of claim 1, wherein the meat product is not cooked by the hot water.

7. The method of claim 1, wherein the meat product has reduced bacterial populations compared to a meat product that is treated with the hot water only, a subzero saline chilling only, or a traditional ice-water chilling only.

8. The method of claim 1, wherein the temperature of the hot water is about 65° C. to about 70° C.

9. The method of claim 1, wherein the carcass is contacted with the hot water for about 0.1 minutes to about 5 minutes, preferably for about 1 minute.

10. The method of claim 1, wherein the carcass is immersed in the at least one water solution for up to about 2 hours.

11. The method of claim 1, further comprising post-chilling the meat product at about 1° C. to 5° C.

12. The method of claim 1, wherein the hot water and/or the at least one water solution comprise propylene glycol and no salt.

13. The method of claim 1, wherein the animal is a poultry or ungulate animal.

14. The method of claim 1, wherein the meat product has decreased Gram-positive and Gram-negative bacterial content.

15. A method of reducing bacteria of a water solution used in meat processing, the method comprising:
a) contacting a carcass of an animal with hot water at a temperature of about 50° C. to 90° C. for about 0.1 minutes to about 10 minutes; and
b) immersing the animal carcass in at least one water solution at a temperature of about −0.6° C. to −6.0° C.,
wherein the water solution has fewer bacteria after immersion of the carcass than when the carcass is not first contacted with the hot water.

16. The method of claim 15, wherein the water solution has fewer Gram-negative and Gram-positive bacteria.

17. A method of reducing cost of meat product production, the method comprising:
a) contacting a carcass of an animal with hot water at a temperature of about 50° C. to about 90° C. for about 0.1 minutes to about 10 minutes; and
b) immersing the carcass in at least one water solution at a temperature of about −0.6° C. to about −6.0° C.;
thereby using less potable water in the method and/or reducing the amount of wastewater in the method compared to a method when not contacting the animal carcass with hot water prior to immersing in the water solution.

18. The method of claim 17, wherein the at least one water solution is used for an extended time compared to a method in which the carcass is not contacted with the hot water.

19. The method of claim 17, wherein the at least one water solution is reused four times or more.

20. The method of claim 17, wherein the at least one water solution does not comprise an antibacterial chemical or disinfectant.
